(19) United States
(12) Patent Application Publication
(10) Pub. No.: US 2006/0224428 A1
(43) Pub. Date: Oct. 5, 2006

(54) Ad-hoc and priority-based business process execution

(76) Inventors: Patrick Schmidt, Heidelberg (DE); Ralf Goetzinger, Walldorf (DE)

Correspondence Address: FISH & RICHARDSON, P.C., PO BOX 1022, MINNEAPOLIS, MN, 55440-1022, US

(21) Appl. No.: 11/097,106

(22) Filed: Mar. 31, 2005

(51) Int. Cl. G05B 19/418

(52) U.S. Cl. 705/8

(57) ABSTRACT

A system and method of executing ad-hoc extensions of a business process instance is disclosed. One or more anchors are provided in a business process definition, where each anchor includes a link to at least one ad-hoc process fragment. User input signals are received to activate or deactivate selected ones of the one or more anchors. One or more ad-hoc process fragments associated with a respective activated or deactivated anchor are respectively inserted into or removed from the business process definition based on the user input signals.

### BACKGROUND

Many companies are re-engineering their enterprise computing systems to be more effective and productive. However, even these companies must continue to integrate with legacy computing systems at their partners. Consequently, enterprise computing systems must be able to run in a distributed and heterogeneous environment, performing complex single tasks in parallel. This need is increasingly being met through the use of workflow-based applications, i.e. software applications executing specific and defined business processes, which are executable modules of code that perform a predefined business function.

Companies need to be continually more flexible to react to ever-changing business conditions. For example, companies using business process-based workflow applications must have the ability to adapt quickly to changes and/or upgrades of existing business processes. Also, the time required for execution of business processes must be minimized, and their execution made more resource-efficient.

The drive for efficiency can make business process management inflexible and not configurable to dynamic company-specific needs. For instance, a business process can be defined according to a process definition, represented by a process graph in a workflow builder tool, and then delivered to a customer for storage and execution. Workflows can be designed for any number of business processes. However, at runtime, a user may wish to add or remove steps to or from a business process, in effect defining a new workflow and changing the business process graph. Such changes are difficult to control and manage, particularly when there is a problem during runtime and the original, unchanged business process must be accessed.

Currently, the process definition allows no prioritization of business processes or groups or portions thereof, other than inherent business scenario rules. For example, a business scenario may dictate the steps of a billing process, whereby invoices are processed and accumulated before a payment mechanism is executed. However, an absence of prioritization, particularly at certain peak times or days and/or for multiple processes running in parallel, can lead to an overuse of processing resources and an associated decrease in efficiency.

### SUMMARY

This document discloses a system and method for executing business processes between two or more business applications. In accordance with one aspect, a method includes the steps of generating a business process definition that defines communication between two or more applications based on a business scenario, and assigning a priority to at least a portion of the communication between the two or more applications.

In accordance with another aspect, a method of executing ad-hoc extensions of a business process instance includes the step of providing one or more anchors in a business process definition, where each anchor includes a link to at least one ad-hoc process fragment. The method further includes the steps of receiving user input signals to activate or deactivate selected ones of the one or more anchors, and inserting into or removing from the business process definition one or more ad-hoc process fragments associated with a respective activated or deactivated anchor based on the user input signals.

In another aspect, a system is provided for executing ad-hoc extensions of a business process instance that governs communication between two or more business applications. The system includes a repository storing one or more business process definitions and one or more ad-hoc process fragments, and a workflow builder that generates a graphical representation of a business process definition, the graphical representation including one or more anchors in the business process definition, each anchor having a link to an ad-hoc process fragment. The system further includes an integration server configured to insert at least one ad-hoc process fragment into a business process definition.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a simplified block diagram of an exchange system for integrated, message-based collaboration.

FIG. 2 is a block diagram of an exchange infrastructure.

FIG. 3 is a detailed block diagram of an integration repository, integration directory, and runtime engine for collaborative processing.

FIG. 4 is a block diagram illustrating a process for communicating a single message between two or more applications.

FIG. 5 is an architectural block diagram of a BPM system including an integration server and a business process engine.

FIG. 6 is a workflow diagram of a BPM system.

FIG. 7 illustrates links to and from business processes.

FIG. 8 illustrates a system for executing ad-hoc extensions of a business process.

FIGS. 9A-C illustrate a process for executing ad-hoc extensions of a running business process instance.

FIG. 10 illustrates a method for executing business processes between two or more business applications according to a priority.

Like reference symbols in the various drawings indicate like elements.

### DETAILED DESCRIPTION

The systems and techniques described here relate to management of business processes that define a message communication protocol between applications in a heterogeneous system landscape. The business process management system and method is optimally implemented in an exchange infrastructure configured to integrate and drive collaboration between various applications in the landscape using open standards and transport protocols such as XML and HTTP.

In an embodiment, a method and system are disclosed for executing ad-hoc extensions of a running business process instance that governs communication between two or more business applications. An ad-hoc process fragments are insertable into a “parent” workflow definition of an original business process workflow. The ad-hoc process fragment can share the same container definition of the parent business process. One method includes providing one or more anchors in a business process definition, where each anchor includes a pointer to at least one ad-hoc process fragment. Each process fragment can be locally-defined based on a runtime environment of an exchange infrastructure that connects the two or more business applications.

Ad-hoc process fragments may also be defined at the process header of the process definition for the original parent business process. During runtime, and according to user input, selected anchors are replaced by the branch of steps defined by the associated ad-hoc process fragment. The ad-hoc process fragments can also include anchors for recursiveness. The inserted fragments can be made visible in a business process graph in a workflow builder application displayed in a graphical user interface. Additionally, steps of the ad-hoc process fragments that are inserted into an original business process can be marked as such to allow easy removal from the business process if desired.

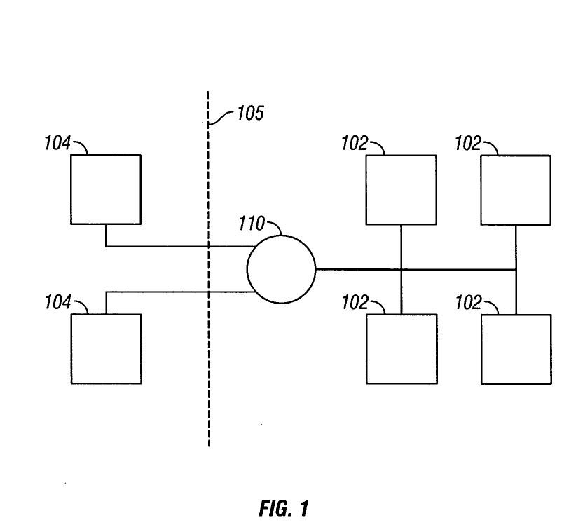

FIG. 1 is a simplified block diagram of a system 100 for integration and message-based interaction of applications. The system 100 includes an exchange infrastructure (XI) 110 for collaborative processing among internal components (ICs) 102 of an enterprise, and between external components (ECs) 104 that communicate to one or more ICs 102 through a firewall 105. The ICs and ECs 102 and 104 represent any of a number of processes or services and their software and hardware, such as Web portals, buying or selling programs, electronic mail, business management programs, project planning programs, etc., and are preferably Web-based applications. Each of the ICs/ECs 102, 104 communicates via messaging with one or more other components according to at least one of a number of communication protocols or standards.

The XI 110 is a self-contained, modularized exchange platform for driving collaboration among the components 102, 104. The XI 110 includes a central integration repository and directory storing shared collaboration knowledge. The XI 110 supports open standards such as various standard markup languages like the extensible markup language (XML), web service description language (WSDL), and simple object access protocol (SOAP) to provide an abstraction of technical interfaces for the components 102, 104, and for message-based communications across heterogeneous component interfaces. The self-contained, modularized functions of the XI 110 can be provided as one or more Web services based on standard Internet technology, and therefore can be published, discovered, and accessed within a network of components 102, 104 using open standards.

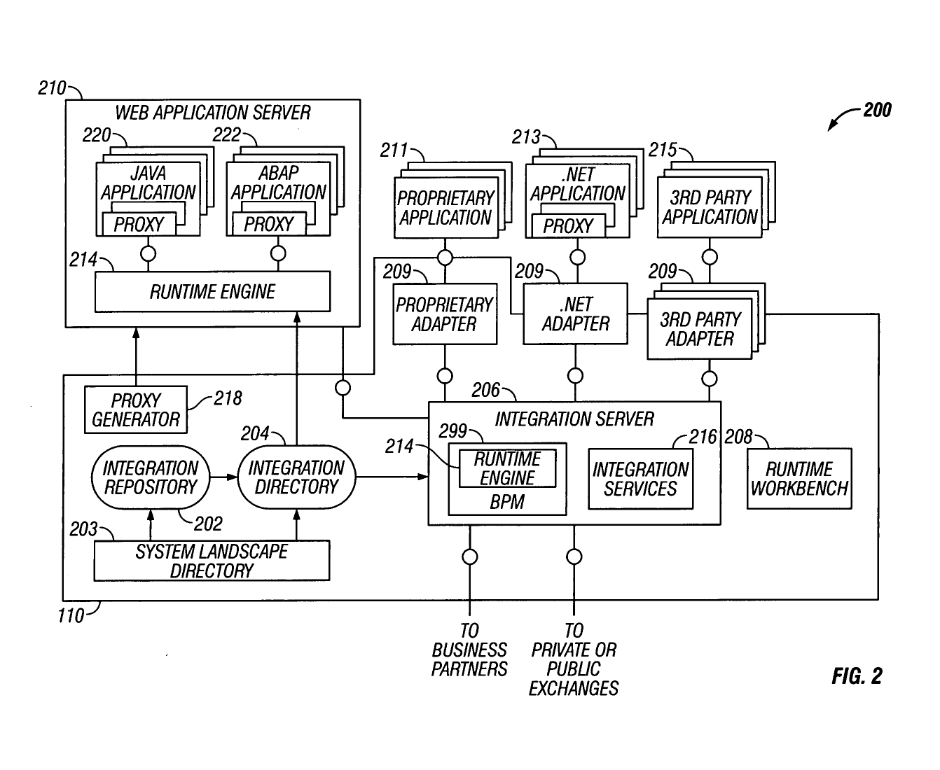

FIG. 2 illustrates a system landscape 200 including an XI 110 for facilitating message-based collaboration among applications. The exchange infrastructure 110 includes an integration repository 202, an integration directory 204, a system landscape directory 203, and an integration server 206. The integration repository 202 captures design-time collaboration descriptions of all software components that can communicate via the XI 110. The integration directory 204 captures configuration-specific collaboration descriptions of the system landscape 200 at runtime, which includes accessing actual component installations from the system landscape directory 203 and connectivity descriptions for external components, all of which represents the shared business semantics of the system landscape 200. The integration server 206 uses the shared business semantics at runtime to execute message-based collaboration among the active software components.

The integration server 206 includes a runtime engine 214 that provides messaging and business process control at runtime for connecting services and managing the process flow of value chains. The runtime engine 214 runs within a business process manager 299. The business process manager 299 governs execution of business processes by the runtime engine 214 at runtime.

The integration server 206 also includes integration services 216 that require an application-specific implementation. Like the integration repository 202 and integration directory 204, the integration server 206 is configured for deployment within any existing system infrastructure. The integration server 206 is preferably a dedicated server that applies the shared collaboration knowledge of the integration directory 204 of the supported system landscape in a runtime collaboration environment. A runtime workbench 208 allows organizations or users to manage the reliable operation of the XI 110.

The XI 110 also includes various adapters 209 that provide connectivity between the integration server 206 and proprietary applications 211, Web-based services 213, and third party applications 215. The XI 110 can also include Web applications server 210 that provides Web-based applications programmed according to standard computing platforms using web-specific programming languages such as Java and ABAP, for instance. The Web applications server 210 also includes an instance of the runtime engine 214 for providing messaging and business process control between Web-based applications such as Java applications 220 and ABAP applications 222, and other components.

New interfaces for software components can be defined using an application component employing a proxy, which allows the interface for the software component to be implemented locally in the XI 110. Proxies make the communication technology stack transparent to applications, and present an application with a programming language-dependent interface. The proxies can be generated by a proxy generator 218 based on information stored on the integration repository 202. The proxy generator 218 uses the interface information described via a standard Web-based language such as WSDL and XSDL to create platform- and programming language-dependent code in the application development system.

The communication logic can be implemented based on the proxy that represents the interface description of the respective development platform, such as Java, ABAP, and NET for the web-based applications 213. The proxies convert platform-specific data types into XML and provide access to the component-specific local integration engine. On the outbound side, proxies are generated completely. Outbound proxies can be called via a service invocation provided by an application's developer. On the inbound side, only proxy skeletons need to be generated, as implemented by the receiving application.

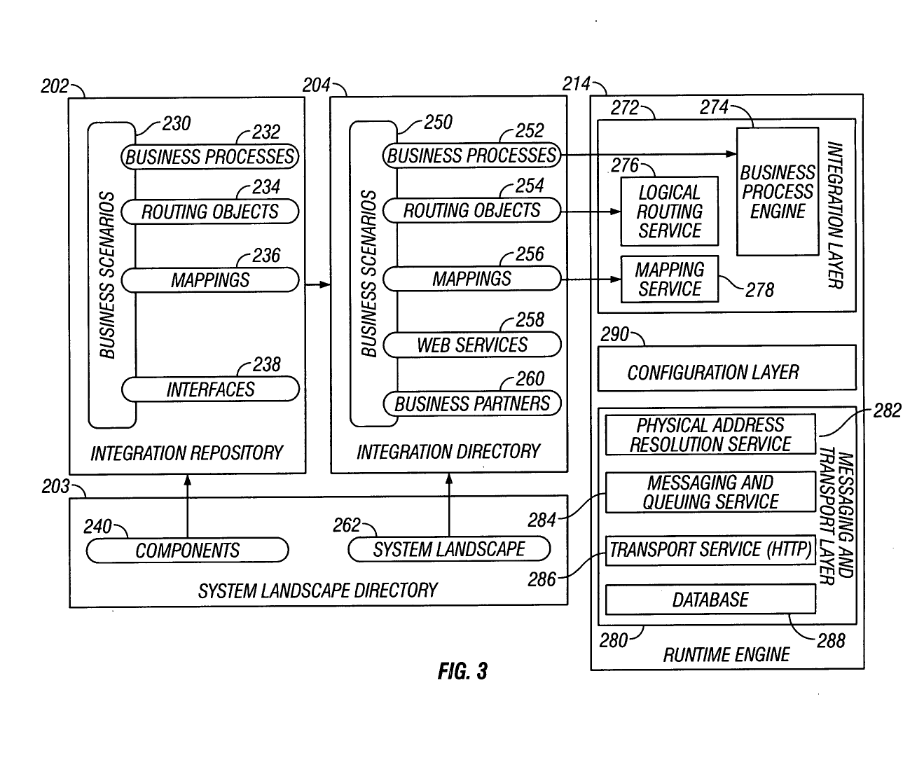

FIG. 3 illustrates the integration repository 202, the system landscape directory 203, the integration directory 204 and an instantiation of the runtime engine 214 in greater detail. The integration repository 202 includes design-time business processes 232, routing objects 234, mappings 236, and interfaces 238, all of which are defined according to one or more business scenarios 230. The integration repository 202 accesses descriptions of all software components 240 in the system landscape from the system landscape directory 203. The business scenarios 230 of the integration repository 202 describe and configure message-based interaction between application components or enterprises. An enterprise can select one or more business scenarios described in the integration repository 202 as a best practice for rapid configuration of the XI 110.

The business processes 232 can be implemented as extensible compound Web services executed using a business process engine 274. Each business process 232 is modeled centrally in the integration repository 202. A company or user designs each business process 232 according to its business needs, independently of the technical implementation. There may be several categories of business process templates: i.e. generic business processes, industry-specific processes, and company-specific processes, for example. Each process identifies the Web services that are needed and that must be interconnected.

In one specific implementation, business processes 232 can be defined in a configuration layer 290. Further, the configuration layer 290 can be used to dynamically reconfigure business processes being executed at runtime. An extensible import/export framework provides import/export facilities for other standards or new versions of business process models. The business process engine 274 (FIG. 2) can then interpret these models and execute them to drive collaboration among software components.

Routing objects 234 are predefined criteria to determine potential receivers of messages that must be distributed between components and business partners during collaborative processing. Information about the routing objects is used for receiver determination to avoid having to process a complete message before distribution. Mappings 236 define required transformations between message interfaces 238, message types, or data types in the integration repository 202. These transformations cover structural conversions and value mappings. Structural conversions are used for semantically equivalent types of messages that are syntactically or structurally different, whereas value mapping may be used when an object is identified by different keys in multiple systems. In a specific implementation, a graphical mapping tool is provided to assist in mapping, and transforming data is based on the Extensible Stylesheet Language Transformation (XSLT) or Java code.

The integration repository 202 is the central point of entry for interface development, storage and retrieval, and includes interfaces 238 that describe all message interfaces of all software components in the system landscape. Accordingly, the interfaces 238 can be implemented on any software component using any technology. Message interfaces are made up of message types, which are in turn made up of data types. The data types can be described using XML Schema Definition Language (XSDL). An example of a data type is “address,” which is used in the message type “Create PO” and can be reused for the message type “Create Invoice.” Interfaces 238 can be arranged according to any classification, such as inbound, outbound and abstract, or synchronous and asynchronous.

The components 240 represent component descriptions that include information about application components, as well as information relating to their dependencies on each other. In a specific implementation, the component descriptions are based on the standard Common Information Model (CIM) of the Distributed Management Taskforce. Since the integration repository 202 includes design-time information, only component-type information, independent of actual installation, is stored as components 240 in the system landscape directory 203. The component descriptions can be added using an API or interactively using a graphical user interface.

The integration directory 204 details information from the integration repository 202 that is specific to the configuration of each component as installed in the system. The configuration-specific collaboration descriptions of the integration directory 204 can be generated automatically from content in the integration repository 202 or manually by a user using a graphical user interface. In one implementation, the integration directory 204 is built on a Java platform and its content is represented via XML using open Internet standards. The integration repository 202 can be upgraded without affecting the integration directory 204 or any runtime collaborative processes. The user then decides which changes should be transferred to the integration directory 204, either as predetermined automatic upgrades or manually via graphical tools.

The integration directory 204 includes configuration-specific descriptions of business scenarios 250, business processes 252, context objects 254, and executable mappings 256. The integration directory 204 also includes descriptions of active Web services 258, and active business partners 260. The integration directory 204 uses a description of the active system landscape 262 from the system landscape directory 203. The business scenarios 250 in the integration directory 204 represent the overall view of the interaction among interfaces and mappings 256 in the context of the actual configuration relevant for the specific implementation. The business processes 252 represents an executable description of all active business processes.

The context objects 254 determine the receivers of a message on a business level. In one specific implementation, the content of a message is used as a context object 254. Other parameters may also be used. Relevant input parameters include the sender, the sender message type, the message to identify the receivers, and the receiver message type. The context object 254 can be described declaratively using XML Path Language (Xpath, i.e. by using a graphical tool) or can be coded in Java. The integration engine 214 at runtime accesses information on the context object 254.

The context objects 254 may use logical terms to describe senders and receivers in order to separate them from the physical address provided by the Web services 258 described in the integration directory 204. The physical address can therefore be changed without changing business-oriented content. Mappings 256 in the integration directory 204 represent mappings required in the active system landscape, in contrast to the integration repository mappings 236 that contains all supported mappings. Some new entries however, such as a new sequence of mappings, can be made only in the integration directory 204 to address additional Web services for mapping, for example. The integration engine 214 accesses the integration directory mappings 256 at runtime.

Context objects 254 provide a unique name for accessing semantically identical payload information. For instance, a context object can provide a unique access name for ‘plant’ for invoice and purchase order. The XPath for ‘plant’ in an invoice can be defined as ‘/A/B/C/plant’ and the XPath for ‘plant’ in a purchase order looks like ‘X/Y/Z/work’. The context object 254 ‘plant’ is assigned to the message interface invoice and purchase order where the XPaths as above mentioned are specified. This makes sure that the XPath for plant is not defined at n different places.

Web services 258 describe interfaces implemented within the current active system landscape, as well as active Web services supported by described business partners 260. As such, information describing Web services 258 can be exchanged with Universal Description, Discovery, and Integration (UDDI) compatible directories or added manually. Each Web service 258 description also provides physical addressing details, access information, and other special attributes such as uniform resource locator (URL), protocol, and security information. In one implementation, the Web services 258 are described in WSDL, and SOAP and ebXML are used as messaging protocols. The integration engine 214 accesses information about the Web services 258 at runtime as well.

The system landscape 262 of the system landscape directory 203 describes the current system landscape that uses the XI 110. The system landscape 262 describes the components that are installed and available on certain machines within the system, the instance or client that was chosen, further information on the installed components, other system landscapes, and so on. The system landscape 262 description is based on an open architecture and can adhere to any widely accepted standard such as the Common Information Model (CIM). Thus, many proprietary and third party components can be configured to automatically register themselves in the system landscape 262 upon being installed within the actual system landscape. Access interfaces to the system landscape 262 description can be based on open standards as well, such as the Web-based Enterprise Management (WBEM) and SOAP standards.

Business partners 262 defines information for business partners of an enterprise, such as names, addresses, and URLs, but may also contain more detailed and sophisticated information. For instance, the business partners 262 may include a description of the message formats that can be directly received and processed, or of security protocols used for safe communications, or trading terms that are employed in the partnership. The kind of information stored in business partners 262 can be governed by enterprise-specific decisions of the enterprise using the XI 110.

The integration directory 204 and the runtime engine 214 form a collaborative runtime environment for executing collaborative business processes. The collaborative runtime environment provides all runtime components relevant for exchanging messages among the connected software components and business partners. The integration server 206 executes the collaborative runtime environment or Web application server 210, either of which can include an instance of the runtime engine 214 in accordance with informational resources provided by the integration directory 204.

The runtime engine 214, which exchanges all messages between the various interconnected components, includes two layers: an integration layer 272 and a messaging and transport layer (MTL) 280. The integration layer 272 includes a business process engine 274 executing centrally modeled business processes, a logical routing service 276 and a mapping service 278. The MTL 280 provides a physical address resolution service 282, a messaging and queuing service 284, a transport service 286 via HTTP, and a database 288. The integration services 216 in the integration server 206 can support the runtime engine 214. An MTL 280 is also included in each instantiation of the runtime engine 214 in Web applications servers 210, as well as in each adapter 209 of the adapter framework connecting to various software components. Each MTL 280 has a role in the execution of the EO protocol, as will be explained further below.

At runtime, business processes 252 are instantiated and executed by the business process engine 274, which executes the respective Web services described in Web services 258 independent of their location according to the business process model. The business process engine 274 is independent of the semantics of the executed business processes 252, and is configured as a mediator and facilitator for business processes 252 to interact with technical components of the runtime system landscape.

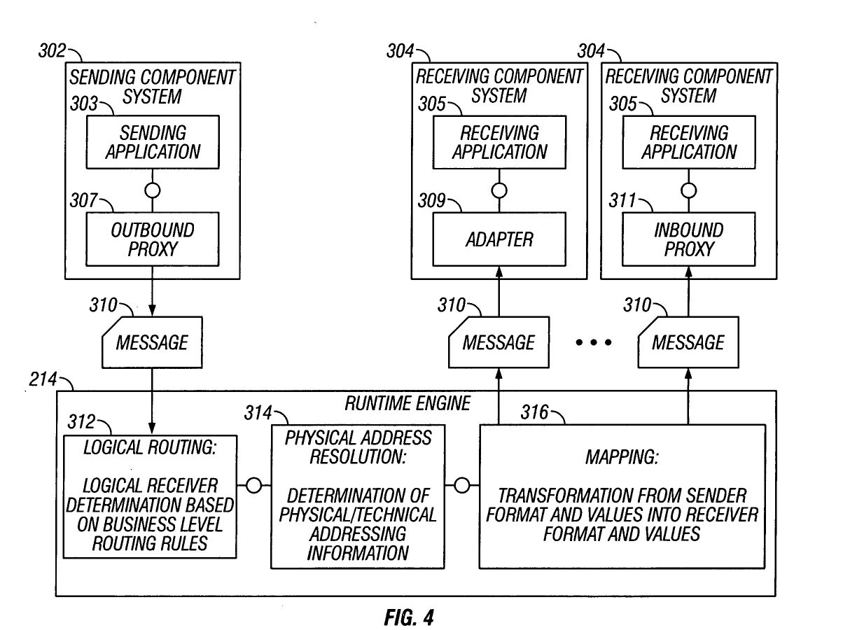

FIG. 4 is a block diagram illustrating several functions of the runtime engine 214 and business process manager 299 (FIG. 2) in a process of exchanging a message between applications. A sending application 303 resides in a sending component system 302, which represents the hardware and software platform of the sending application 303. One or more receiving applications 305 each reside in a receiving component system 304. A communication path for a message 310 can include an outbound proxy 307 at the outbound interface from the sending component system 302, through the runtime engine 214 and adapter 309 to the receiving component system 304.

A receiving component system 304 may also utilize an inbound proxy 311 rather than an adapter. The configuration and connectivity of the shown receiving component systems 304 is merely exemplary, and it should be noted that such configuration and connectivity could take any number of forms. The pictured example illustrates both asynchronous and synchronous communication. In synchronous communication, routing and physical address resolution is only needed for the request as the response is transferred to the sender, which is already known.

For a given message the logical routing service 276 uses information on the sending application and the message interface to determine receivers and required interfaces by evaluating the corresponding routing rules, as shown at 312. The routing rules are part of the configuration-specific descriptions of the runtime system landscape provided by the integration directory 204, and can be implemented as XPath expressions or Java code. The mapping service 278 determines the required transformations that depend on message, sender, and sender interface, as well as the receiver and receiver interface, at 314. In the case of asynchronous communication, even the message direction is determined to appropriately transform input, output, and fault messages.

After retrieving the required mapping from the integration directory 204, the mapping service 278 can either execute XSLT mappings or Java code (or any combination in a given sequence) to the content of the sent message. Below the integration layer, messaging, queuing, and transport services 284 move the message to the intended or required receiver(s). After the message is transformed into the format expected by each receiver, the physical address of the required receiver service and other relevant attributes are retrieved from the integration directory 204 and mapped to the message, at 316.

A queuing engine (not shown) in the messaging and queuing service 284 stores ingoing, outgoing, erroneous, and work-in-progress messages persistently. The messaging layer of the runtime engine 214 provides queuing functions for the physical decoupling of application components and guarantees messages are delivered exactly once. The transport service 286 enables the runtime engine 214 to act as both a client and server. The transport service 286 implements a client that enables outbound communication and a server that handles inbound communication by accepting incoming documents. Additional server functions can address situations in which the receiver has no server by supporting polling over the transport protocol used. HTTP is preferably used, but other transport protocols may be used as well.

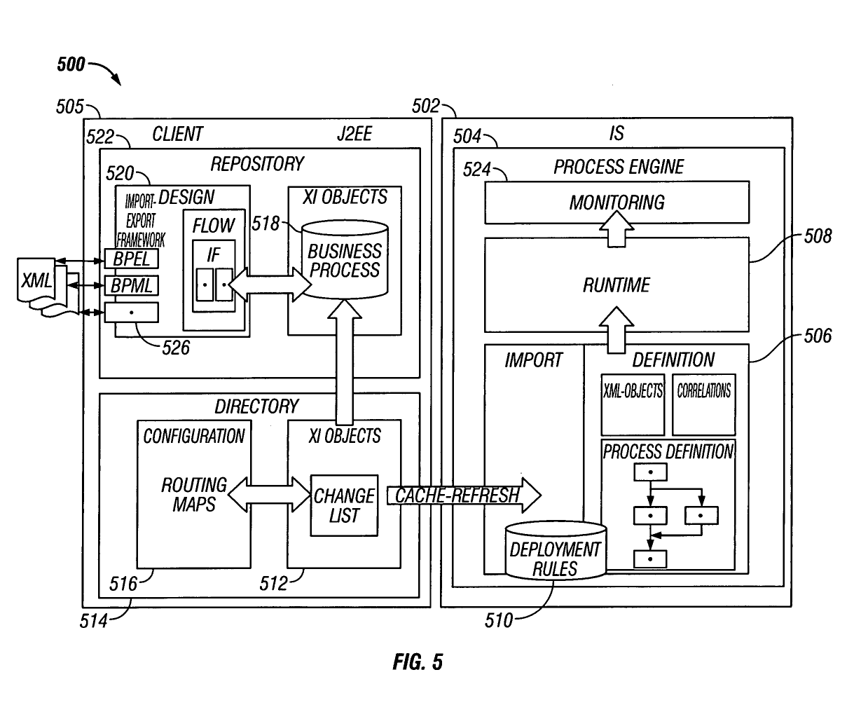

FIG. 5 depicts a functional block diagram of a business process management system 500. The system 500 includes a process engine 504 integrated in an integration server 502. The process engine 504 and integration server 502, as they are called in their runtime configurations, are also respectively known as a process editor and an integration builder in their “definition time” configurations. Process definition 506 and BPM runtime 508 in the BPM system 500 are based on different development platforms. For instance, the process definition 506 is based on Java, such as a J2EE platform 505, and the runtime 508 is based on ABAP. The BPM system 500 includes monitoring and administration tools 524 on the integration server 502.

The process definition 506 module utilizes XML objects and correlations to define processes, based on deployment rules imported from XI objects 512 from the integration directory 514. The XI objects 512 are based on the routings and mappings defined for the system runtime configuration 516. The XI objects 512 are also used to define business processes 518 in the integration repository 522, and the design-time configuration 520 of the system landscape.

Business processes 518 are integrated with and linked with other objects and tools in the integration repository 522. Business processes 518, in the form of patterns and templates, can be delivered to customers. Application-specific content can also be delivered. The BPM system 500 includes an import/export framework 526 that imports and exports standards-based adapters for universal connectivity. The BPM system 500 can include an interface for receiving user-specified business process details.

Business process modeling scenarios, called “patterns,” are high-level building blocks that can be combined with each other and with atomic functions such as deadlines, exceptions, etc. of the process engine 504. The following are example patterns:

1) Send and Receive: Sending messages controlled by the process engine 504 is often combined with receive steps that wait for a correlated response message. A receive step should wait for the messages starting with the activation of the associated correlation as a queuing mechanism.

2) Serialization: This pattern can include the following steps: 1. Receive messages and store them locally in the process data context; 2. Keep the data context and start sending received messages when a certain condition has been fulfilled; and 3. Send received messages in a given order respecting dependencies of receivers. This third step can be: a. Without caring about responses/acknowledgements (“fire and forget”); or b. Receiving a response or an acknowledgement (enables serialization). The process engine 504 can be configured to wait for a technical ACK of or business response from a previously-sent message before sending a next message.

3) Transformations/Merge/Split: The process engine 504 transforms messages within the process context. The following transformations can be performed: 1. (N:1) Transform several collected messages to one new message (e.g. transform several invoices to one combined invoice or transform PO header and several PO positions into one PO); 2. (1:N) Transform one message into several other messages (e.g. transform a combined in-voice to invoice respecting the original POs); and 3. (1:1) is a special case of the transformations described above. N:M mappings are also possible if needed.

4) Multicast: The process engine 504 can be configured to calculate the receivers of a message (also using content-based conditions) and to send the message to these receivers, either without regard to responses/acknowledgements (“fire and forget”) or based on receiving a number of responses/acknowledgements. Messages may be sent out in parallel or sequentially.

5) Collect: This pattern uses receive steps in which an arbitrary number of messages can be received. From a process point of view, the end of the collecting scenario can be defined via “push,” (i.e. a certain condition is reached, such as N messages have arrived, a certain deadline has been reached, etc.), or “poll” in which the process engine waits for a special message that indicates the end of collecting.

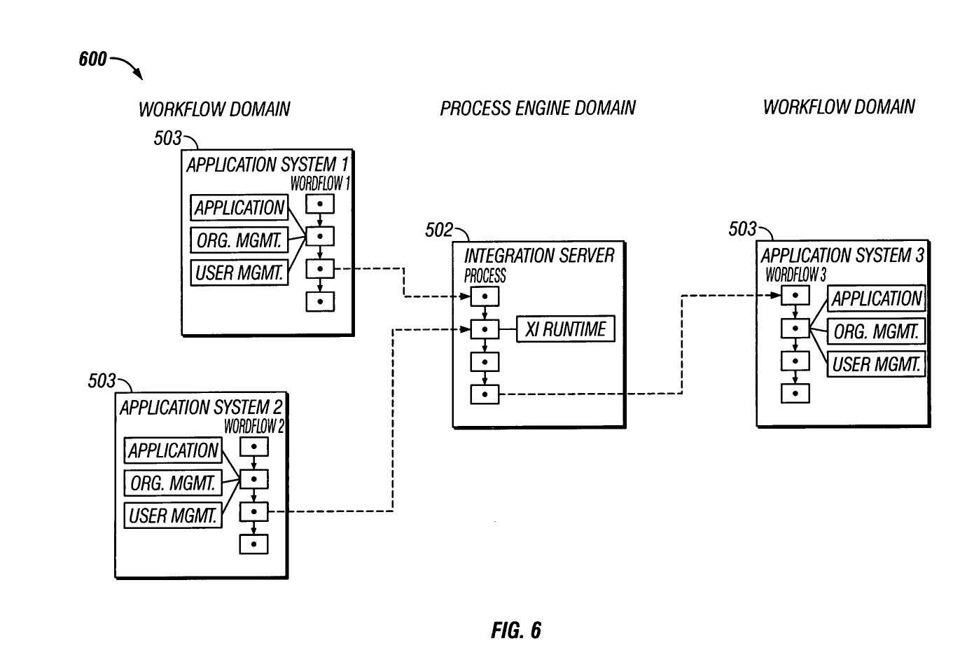

FIG. 6 illustrates an example workflow 600 of a BPM system runtime and respective process engine of the integration server 502 orchestrating several “client” application systems 503. The integration server 502 is a standalone component that communicates via messages with the client application systems 503. Message-related functions (send, create, transformation, merge, split, etc.) are preferably realized by service calls to messaging layer of the integration server 502 (‘lower-level XI-runtime functions’). The process engine 504 preferably does not change the message-payload directly. Rather, messages are changed by transformation, which is explained further below.

The process engine 504 uses business processes on the integration server 502. While it is able to communicate with backend processes via messages, the process engine 504 does not interact with the applications, organizational and user management functions in the backend system(s). The process engine 504 uses the messaging layer application, while business workflow uses the application, user, and organizational management of the respective application system. The process engine 504 supports the communication via synchronous outbound interfaces.

Processes will have representations both in the integration repository 522 and the integration directory 514. Process definitions are stored in the integration repository 522. This allows the transport of process definitions to the client systems 503. Processes stored in the integration directory 514 point to an associated process definition in the integration repository 522. Business processes 518 include public parts, such as previously-used interfaces, and private parts, which include the process graph using step types and correlations. Process instances can be stopped and restarted in runtime 508. Process instances can also be restarted from any particular step (e.g. if an error occurs during a certain step, restart from that step).

Each business process, as an XI object that is visible in a navigation tree and usable in links from and to other XI objects, will provide the ability to integrate the process engine 502 in the XI environment. Business processes 518 can use established XI object types, and will not create redundant object types.

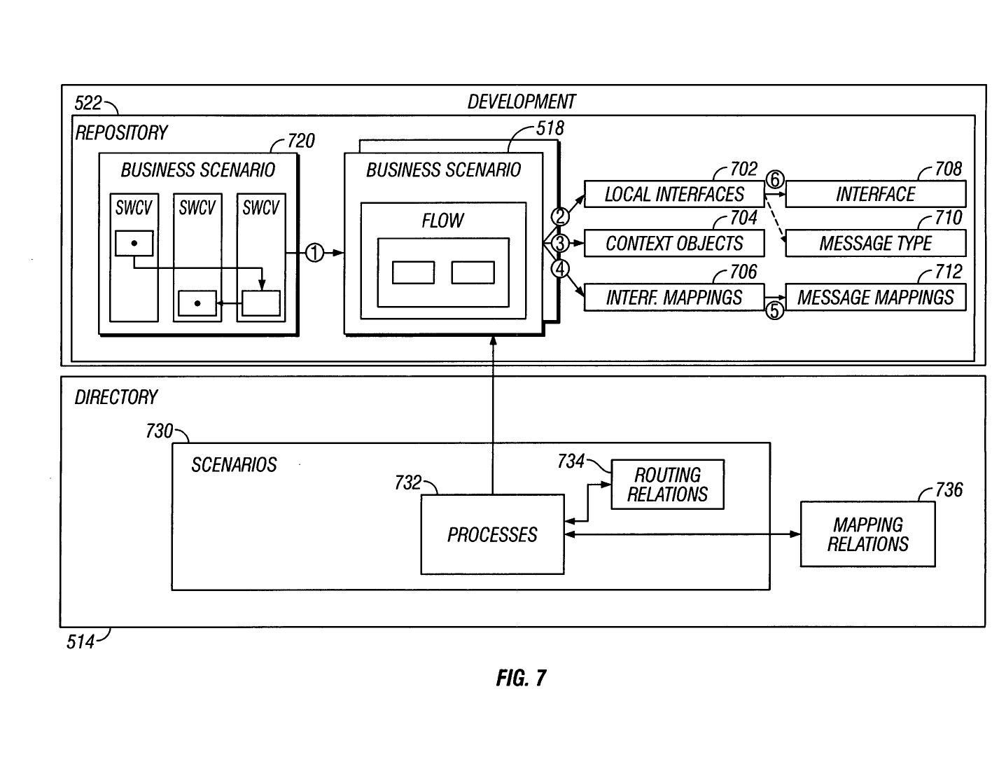

FIG. 7 illustrates links to and from business processes 518 in the integration repository 522. The links include references to: (2) abstract interfaces 702; (3) context objects 704; and (4) interface mappings 706. Absolute links include: (1) the action of a business scenario references a process definition; (5) an interface mapping 706 references a message mapping 712. Business processes 518 can be used in business scenarios 720, and will act as brokers between business systems.

A business process 518 “owns” a process interface 708 which reflects all inbound and outbound communication. Interfaces used in the process interface 708 include two types: process-specific interfaces (a special normalizing interface for the process); and mirrored outbound/inbound interfaces of sending/receiving business systems (to avoid the creation of unnecessary interfaces). Mirroring must be done creating a new abstract interface 702 pointing to the same message type as the original interface. Abstract interfaces 702 can be used in an inbound as well as in an outbound role.

Should the process need inbound and outbound messages, a transformation from inbound to outbound can be executed. In addition, process-specific interfaces do not need to have proxies in the attached business systems. This leads to the so-called abstract interfaces 702, which are the only type of interfaces that can be used by the business processes 518. Local interfaces may reference other interfaces 708 (to handle the mirroring) and they also may reference message types 710 (to realize process-specific interfaces). Context objects 704 can be used to access payload information via name or other message content. Data may not be written to context objects 704. Interface mappings 706 are addressed by a business process 518 within the transformation step.

A business scenario 720 may reference one or more business processes 518. One business process occupies one “swim lane” or process flow. Each process is treated as a business system. Actions within process swim lanes are not stored as separate actions that are reusable. An action represents an interface used by a business process 518 as outbound or inbound interface (or both). In a ‘normal’ scenario case, not all interfaces of an action must be a target or source of a connection. In a business process definition, each action represents one interface with inbound and/or outbound semantics and must be used as a target and/or source in a connection.

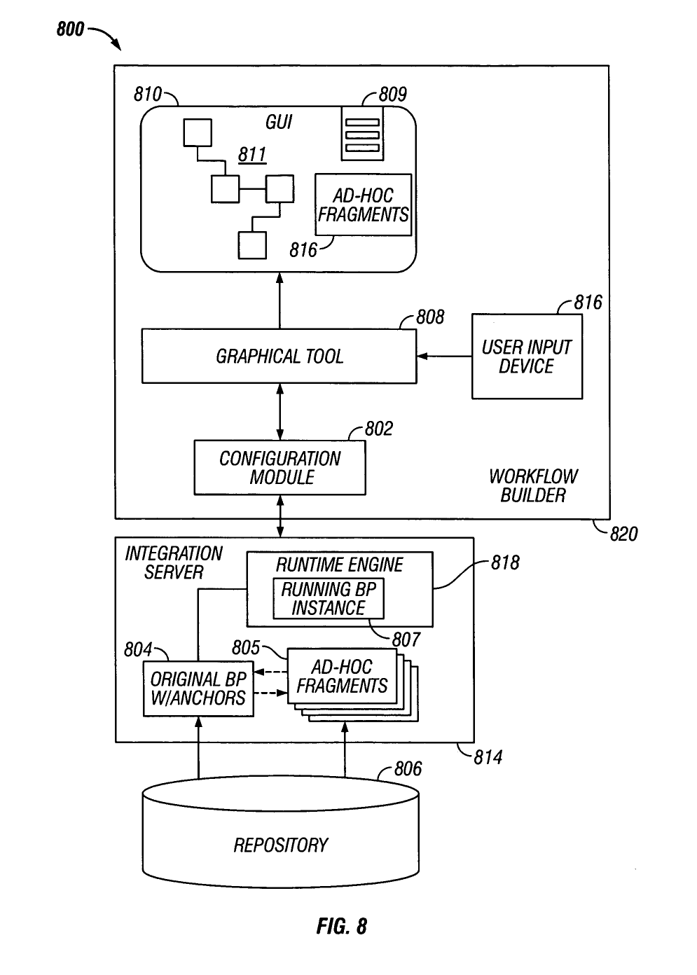

FIG. 8 shows a system 800 for executing ad-hoc extensions of running business process instances. The system 800 includes a workflow builder 820 connected with an integration server 814. The workflow builder 820 can be embodied as an application program, in hardware, or in firmware, or a combination thereof. The workflow builder 820 includes a configuration module 802 that provides directions to the integration server 814 to insert or remove one or more ad-hoc process fragments 805 to or from an original business process 804 accessed from a repository 806. The repository 806 can include a first container that defines the original business process 804, and a second container having process definitions for the one or more ad-hoc process fragments 805.

The one or more ad-hoc process fragments can be defined locally or externally to the system 800. The ad-hoc process fragments 805 removed from or combined with the original business process 804 results in an runtime business process 807 for execution by a runtime engine 818. The runtime business process 807 will be the process that governs communication between two or more business applications according to one or more business scenarios.

Ad-hoc process fragments 805 are selected for removal or insertion into the original business process 804 by anchors provided in the process definition of the original business process 804. The original business process 804 can be represented in a graphical user interface 810, and displayed as a process graph 811 generated by a graphical tool 808. The graphical tool 808 can also generate a graphical representation of one or more ad-hoc process fragments 816. The graphical user interface 810 can also include control functions such as a menu 809 or other control devices, which can be used to modify the process graph 811 with the insertion or deletion of a graphical representation of one or more ad-hoc process fragments 816, as directed by user inputs from a user input device 816 connected with the graphical tool.

In an embodiment, the user input device 816 is a keyboard, a mouse, other input device or combination thereof. The graphical tool 808 can be a processor running in a computer or on a network in accordance with instructions provided by a graphical tool computer program. The graphical user interface 810 can be provided in a video monitor or other type of display. Accordingly, the ad-hoc process fragments 805 can be defined locally using the user input device 816 and graphical user interface 810, and stored in the repository 806 for runtime use.

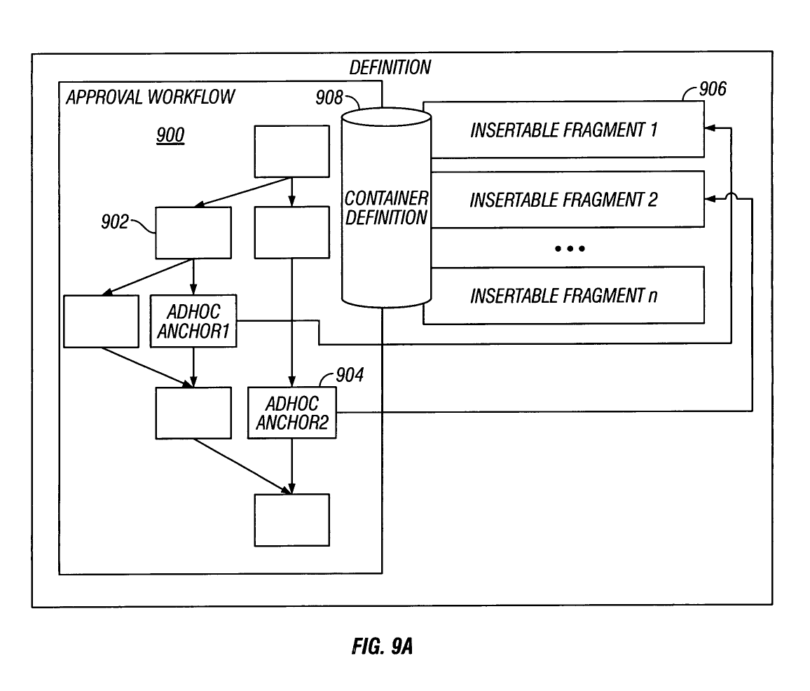

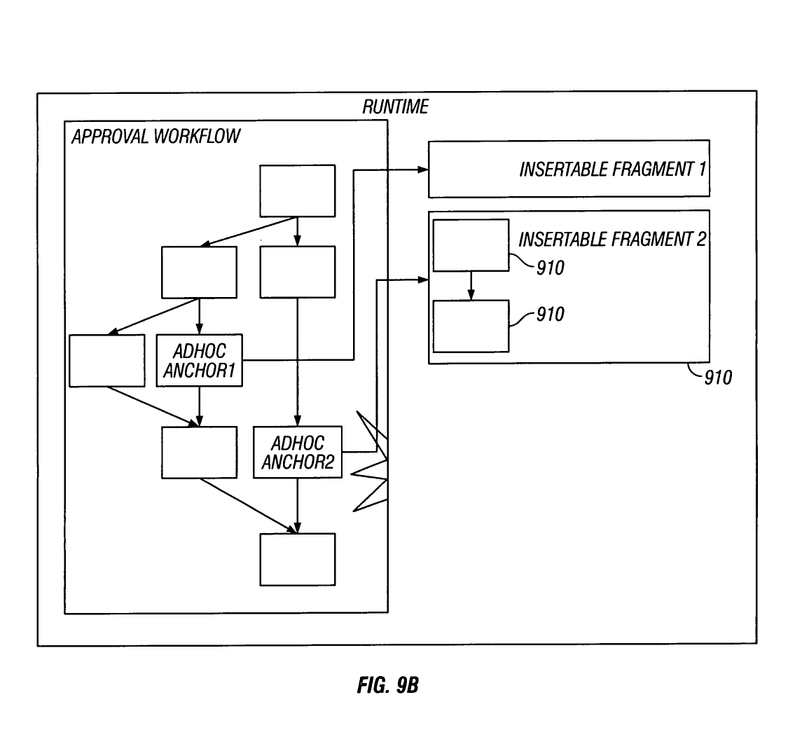

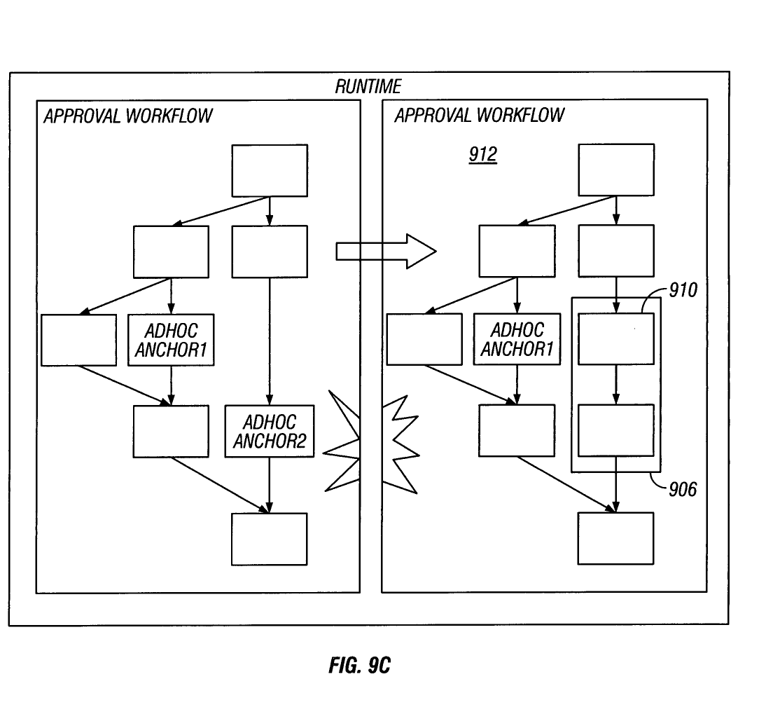

FIGS. 9A-C illustrate a process for executing ad-hoc extensions of a running business process instance. FIG. 9A illustrates an original business process definition 900, representing a business process that includes a number of steps or sub-processes 902. Each step 902 represents an action or communication process to be taken between two or more business applications. The business process definition 900 also includes one or more anchors 904. Each anchor 904 includes a pointer to at least one insertable ad-hoc process fragment 906. Each ad-hoc process fragment 906 can include an anchor that facilitates removal or deactivation from the original business process.

FIG. 9B illustrates a runtime configuration, in which each ad-hoc process fragment 906 includes a number of fragment steps or sub-process 910 that represent an action or communication process to be taken between the two or more business applications, but which are not part of the original business process definition 900. By activating an anchor 904 within the original business process definition 900, at least one of the ad-hoc process fragments 906 is selected for insertion into the original business process. Conversely, selecting or deactivating an anchor in an ad-hoc process fragment 906 can remove the ad-hoc process fragment from the original business process definition 900.

FIG. 9C illustrates a selected anchor 904 (anchor 2) being replaced with an ad-hoc process fragment 906 (insertable fragment 2), including all fragment steps 910 defined for that ad-hoc process fragment 906. Thus, the runtime business process 912 includes fragment steps 910, which may also include their own anchors for identifying all fragment steps 910 of the added ad-hoc process fragment 906 that can be selectively removed. The process header definition can host adhoc fragments for all adhoc anchors.

In another embodiment, a priority or set of priorities can be assigned to a business process and executed at runtime. The priority is configurable via the workflow builder. The priority can be based on any number of factors, including but not limited to, time, period, class, etc. For example, business processes can be assigned to one or more classes, and a priority for each business process can be assigned to the same class or classes. Other factors of priority are also possible. Priorities may also be assigned to a business process on an ad-hoc basis.

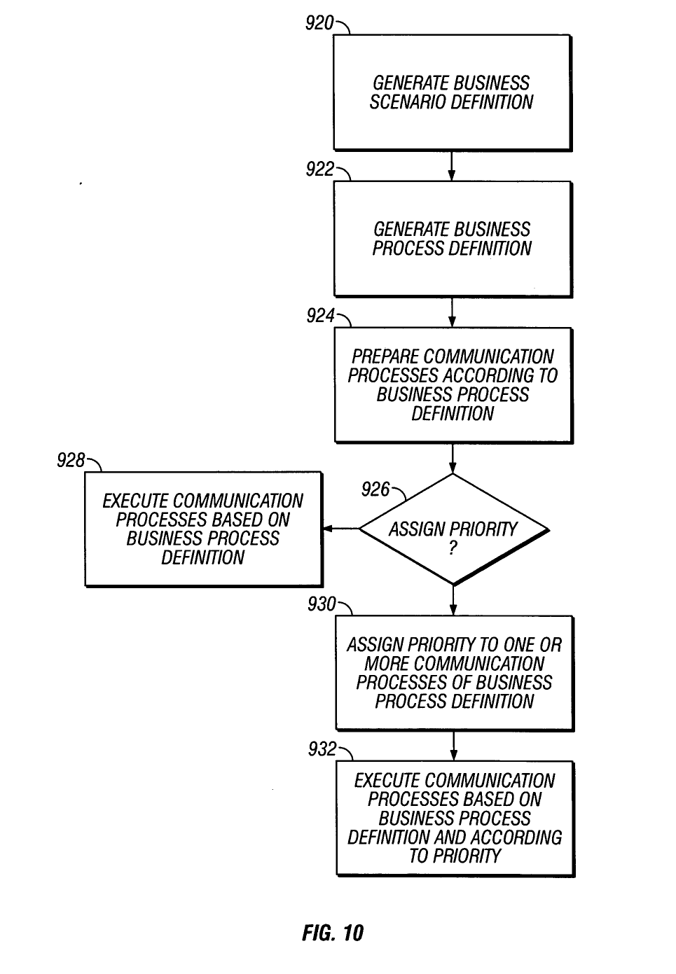

FIG. 10 illustrates a method for executing business processes between two or more business applications according to a priority. The priority can be based on time, period, class or ad-hoc, and can be one or more priorities. At 920, a business scenario is defined and generated. The business scenario defines message communication that should occur between the two or more business applications. At 922 a business process definition is generated based on the business scenario. The business process definition defines executable communication processes between the two or more business applications.

At 924, communication processes are prepared according to the business process definition. For instance, logical addresses, interfaces and routing objects are defined for the communication processes, to enable messages to be processed by the integration server and runtime engine, and be routed from the sending application to the correct receiving application. At 926, a determination is made whether a priority is to be assigned to the business process definition. If no priority is to be assigned, the communication processes are executed by the runtime engine based on the business process definition, at 928.

If a priority is to be assigned, at 930 a priority is assigned to one or more communication processes of the business process definition. In an embodiment, the priority is assigned to the entire business process. Alternatively, only portions of the business process are assigned the priority. The priority can be based on a time. For example, the communication processes of the business process can be prioritized to be executed at a particular time. The priority can also be based on a time period, on a class, or even assigned ad-hoc. At 932, the communication process are executed based on the business process definition and according to the assigned priority.

Although a few embodiments have been described in detail above, other modifications are possible. The logic flows depicted in FIGS. 9 and 10 do not require the particular order shown, or sequential order, to achieve desirable results. Other embodiments may be within the scope of the following claims.

1. A method of executing ad-hoc extensions of a business process instance, the method comprising:
providing one or more anchors in a business process definition, each anchor including a link to at least one ad-hoc process fragment;
receiving user input signals to activate or deactivate selected ones of the one or more anchors; and
inserting into or removing from the business process definition one or more ad-hoc process fragments associated with a respective activated or deactivated anchor based on the user input signals.

2. A method in accordance with claim 1, wherein the link includes a pointer from the anchor to the ad-hoc process fragment.

3. A method in accordance with claim 1, wherein user input signals are received at runtime of a business process based on the business process definition.

4. A method in accordance with claim 1, further comprising displaying a process graph representing a workflow defined by the business process definition.

5. A method in accordance with claim 4, further comprising displaying, in the process graph, symbols representing the one or more anchors in the business process definition.

6. A method in accordance with claim 5, further comprising displaying a graphical representation of at least one ad-hoc process fragment associated with one of the one or more anchors.

7. A method in accordance with claim 5, further comprising generating a runtime process graph that combines a process graph representing the workflow defined by the business process definition with the graphical representation of the at least one ad-hoc process fragment.

8. A system for executing ad-hoc extensions of a business process instance that governs communication between two or more business applications, the system comprising:
a repository storing one or more business process definitions and one or more ad-hoc process fragments;
a workflow builder that generates a graphical representation of a business process definition, the graphical representation including one or more anchors in the business process definition, each anchor having a link to an ad-hoc process fragment; and
an integration server configured to insert at least one ad-hoc process fragment into a business process definition.

9. A system in accordance with claim 8, wherein the workflow builder further includes a user input device for receiving user inputs to select at least one of the one or more anchors to insert an associated ad-hoc process fragment into the business process definition.

10. A system in accordance with claim 8, wherein the integration server includes a runtime engine configured to execute a business process according to the business process definition.

11. A system in accordance with claim 9, wherein the workflow builder further includes a graphical tool responsive to the user inputs and configured to generate the graphical representation of the business process definition.

12. A system in accordance with claim 8, wherein each anchor is represented by a symbol.

13. A system in accordance with claim 12, wherein the graphical tool is further configured to replace the symbol with a graphical representation of the ad-hoc process fragment based on selection of the anchor.

14. A method for executing business processes between two or more business applications, the method comprising:
generating a business process definition that defines communication between two or more applications based on a business scenario;
assigning a priority to at least a portion of the communication between the two or more applications.

15. A method in accordance with claim 14, wherein assigning a priority includes assigning a time period during which the communication between the two or more applications can be executed.

16. A method in accordance with claim 14, further comprising providing the business scenario in a repository.

17. A method in accordance with claim 14, further comprising:
assigning the business process definition to a class; and
assigning the priority to the class.

18. A method in accordance with claim 14, further comprising executing the communication between the two or more applications based on the business process definition and according to the priority.

19. A method for executing business processes between two or more business applications, the method comprising:
providing a business scenario in a repository, the business scenario defining messaging activity between the two or more business applications;
generating a business process definition based on the business scenario;
generating a graphical representation of the business process definition in a display; and
receiving user input indicating a priority to be assigned to at least a portion of the business process definition.

20. A method in accordance with claim 19, further comprising executing the messaging activity between the two or more business applications based on the business process definition and according to the priority.
